(19) United States
(12) Patent Application Publication
(10) Pub. No.: US 2008/0022323 A1
(43) Pub. Date: Jan. 24, 2008

(54) REMOTELY OPERABLE RECORDING DEVICE

(76) Inventor: Tin Yue KOO, Hong Kong SAR (HK)

Correspondence Address: Tin Yue Koo, Flat 2, 14/F, Block B Ka Wai Building, 146-166 Java Road, North Point, Hong Kong, omitted

(21) Appl. No.: 11/428,919

(22) Filed: Jul. 6, 2006

(51) Int. Cl. H04N 7/173; H04N 7/18

(52) U.S. Cl. 725/81; 725/133; 725/122; 725/74; 725/78

(57) ABSTRACT

Disclosed herein is a command receiving device (1200) for controlling an electronic device operable using wirelessly transmitted commands. The command receiving device (1200) includes: a network interface (1210) for coupling to a communications network; a control interface (1240) for coupling to said electronic device; a memory (1230) for storing a set of one or more control commands recognised by said electronic device; and a processor (1220) coupled to the network interface (1210), the control interface (1240), and the memory (1230). The processor (1220) translates at least one command received from said communications network via said network interface (1210) to at least one of said control commands, said control interface transmitting said at least one control command to said electronic device to control said electronic device. The electronic device may include, for example, a recording device or a signal source device.

### FIELD OF THE INVENTION

The present invention relates generally to control of electronic equipment and, in particular, to remotely operable multimedia devices.

### BACKGROUND

Recording devices are frequently used in domestic and commercial environments to record television broadcasts and the like. Such recording devices include video cassette recorders (VCRs), Digital Versatile Disc (DVD) recorders, and hard-disk recorders. A user typically controls these recording devices by operating controls on the actual device, by operating a remote control connected to the device by a cord, or by operating a remote control that communicates with the device using a line of sight wireless transmission path. The wireless communication path is typically an infrared wireless transmission path. The recording devices store broadcast program data on a storage medium, such as magnetic tape, a magnetic disc, or an optical disc.

Each of the known modes of operation requires a user to be in close proximity to the recording device. Further, a user wanting to record a program must have ready access to a television broadcast timetable in order to select at least an associated channel and start time for the program to be recorded. The most simple mode of operation involves a user selecting a channel at the time a desired program begins and then issuing a record command to initiate recording of the program by the recording device. On completion of the program broadcast, the user issues a stop command.

It is often desirable to record programs when a user is not available to watch the program, or if the user wants to watch a program numerous times. For example, a home user may want to record a movie that is to be broadcast late at night, or when the user is not at home. Accordingly, most recording devices provide capabilities to schedule the recording of programs. However, in order to program the recording device with a desired schedule, the user must first know a minimum set of program parameters, which may include, for example, a channel on which the program is to be broadcast, a program start time, and a program end time. The set of program parameters may alternatively include a G-code. G-code is a coding system that seeks to simplify the recording of programs. Each program is associated with a G-code. The G-codes are listed in television program timetables, and the user enters a G-code associated with a program to be recorded into the recording device. The recording device interprets the G-code to determine the channel, program start time and program end time associated with the program to be recorded. In one implementation, a recording device is supplied with a handheld scanning device. A user utilises the handheld scanner to scan G-codes from a printed television program timetable. The user then transmits scanned G-codes to the recording device.

Circumstances arise under which a user is unable to operate a recording device directly. For example, a user is alerted to the broadcast of a program when away from home, but is unable to return home in sufficient time to activate the recording device. In another situation, a user forgets to schedule or activate the recording device, and is unable to return home to activate the recording device. Further, a user may be away from home and realise that a special broadcast of a favourite program is scheduled to run for longer than the usually scheduled time.

Thus, a need exists to provide a recording device that is capable of remote operation by a user.

### SUMMARY

It is an object of the present invention to overcome substantially, or at least ameliorate, one or more disadvantages of existing arrangements. According to a first aspect of the present disclosure, there is provided a command receiving device for controlling an electronic device operable using wirelessly transmitted commands, said command receiving device comprising:

a network interface for coupling to a communications network;

a control interface for coupling to said electronic device;

a memory for storing a set of one or more control commands recognised by said electronic device; and

a processor coupled to the network interface, the control interface, and the memory;

wherein said processor translates at least one command received from said communications network via said network interface to at least one of said control commands, said control interface transmitting said at least one control command to said electronic device to control said electronic device.

According to a second aspect of the present disclosure, there is provided a remotely operable system for controlling an electronic device operable using wirelessly transmitted commands, comprising:

an electronic device operable using wirelessly transmitted commands; and

a command receiving terminal including:
a network interface for coupling to a communications network;
a control interface for coupling to said electronic device;
a memory for storing a set of one or more control commands recognised by said electronic device; and
a processor coupled to the network interface, the control interface, and the memory;

wherein said processor translates at least one command received from said communications network via said network interface to at least one of said control commands, said control interface transmitting said at least one control command to control said electronic device.

According to a third aspect of the present disclosure, there is provided a remotely operable system, comprising:

a command sending terminal adaptable for coupling to a communications network;

an electronic device operable using wirelessly transmitted commands; and

a command receiving terminal including:
a network interface for coupling to said communications network;
a control interface for coupling to said electronic device;
a memory for storing a set of one or more control commands recognised by said electronic device; and
a processor coupled to the network interface, the control interface, and the memory;

wherein said processor translates at least one operating command received from said command sending terminal via said network interface to at least one of said control commands, said command receiving terminal transmitting said translated control commands via said control interface to control said electronic device.

In one embodiment, the electronic device is one of a recording device and a signal source device.

According to another aspect of the present disclosure, there is provided a computer program product including a computer readable medium having recorded thereon a computer program for implementing any one of the methods described above.

Other aspects of the invention are also disclosed.

### BRIEF DESCRIPTION OF THE DRAWINGS

One or more embodiments will now be described with reference to the drawings, in which:

FIG. 1 shows a schematic block diagram representation of a remotely operable recording system in accordance with an embodiment of the present disclosure;

FIG. 2 shows a schematic block diagram representation of a remotely operable recording system in accordance with another embodiment of the present disclosure;

FIG. 3 is a flow diagram of a method of remote operation of a recording device according to an embodiment of the present disclosure;

FIG. 4 is a schematic block diagram representation of a remotely operable recording system in accordance with an embodiment of the present disclosure;

FIG. 5 is a flow diagram of a method of setting up a user profile associated with a recording device according to an embodiment of the present disclosure;

FIG. 6 is a flow diagram of a method of a caller leaving a voicemail according to an embodiment of the present disclosure;

FIGS. 7A and 7B are a flow diagram of a method of a caller establishing a call to a recording device according to an embodiment of the present disclosure;

FIG. 8 shows a schematic block diagram representation of a remotely operable recording system in accordance with another embodiment of the present disclosure;

FIG. 9 is a flow diagram of a method of setting up the remotely operable recording system of FIG. 8;

FIG. 10 is a flow diagram of a method of remotely programming the recording system of FIG. 8;

FIG. 11 is a flow diagram of a method of activating remote recording in accordance with the present disclosure;

FIG. 12 is a schematic block diagram of a command receiving device in accordance with the present disclosure; and

FIG. 13 is a schematic block diagram of a general purpose computer upon which arrangements described can be practised.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

The principles of the preferred method described herein have general applicability to remote operation of electronic devices, particularly those electronic devices that are operable using wirelessly transmitted commands. However, for ease of explanation, the steps of the preferred method are described with reference to video cassette recorders, DVD recorders, and hard-disk recorders. However, it is not intended that the present invention be limited to the described method. For example, the invention may have application to control of a personal computer running the Microsoft Windows XP Media Center operating system. The invention may also have application to other electronic devices, such as a signal source device. A signal source device may include, but is not limited to, a television, a set-top box, a video camera, and a television tuner.

Disclosed herein is a recording system that is remotely operable by a user. In one embodiment, an electronic device operable using wirelessly transmitted commands, in the form of a recording device, is adapted to receive remote user commands via a communication link, such as a telephone line or Internet connection. In a particular embodiment, the user commands take the form of Dual Tone Multi-Frequency (DTMF) tones transmitted over a conventional telephone line or via a Voice over Internet Protocol (VoIP) connection.

In one embodiment utilising a telephone line, a user utilises a command sending terminal, such as a touch tone telephone, mobile telephone or the like, to call a command receiving device embedded within or associated with a recording device. In a further embodiment, the command receiving device is associated with an answering machine or voicemail device.

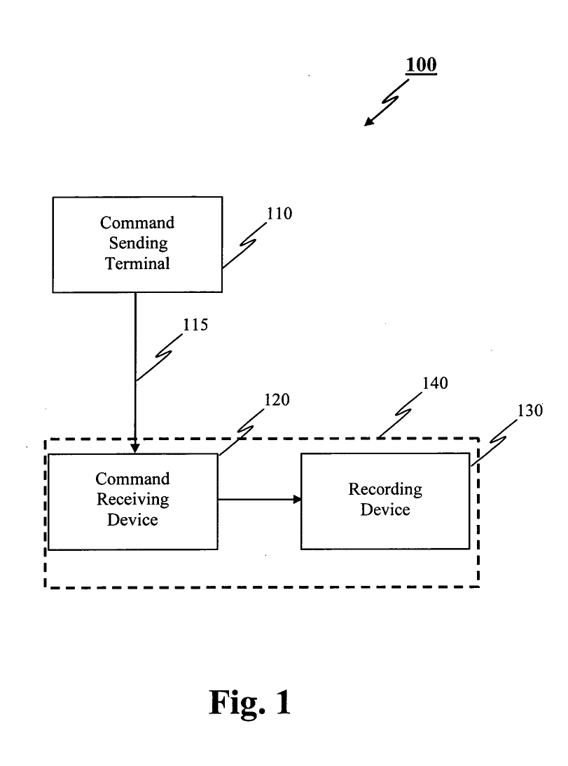

FIG. 1 is a schematic block diagram representation of a system 100 for remote operation of a recording device 130. The system 100 includes a command sending terminal 110 and a command receiving device 120. The command sending terminal 110 is located remotely from the command receiving device 120. The command sending terminal 110 may be implemented using, for example, a telephone, a mobile telephone, a computer, or other communication device capable of transmitting data, such as DTMF tones, to the command receiving device 120.

A user wanting to control the remote recording device 130 provides commands to the command sending terminal 110. The commands may relate to any functionality embodied in the recording device 130, and may include, for example, direct activation of a recording function of the recording device 130, scheduling the recording device 130 to record a broadcast program at some time in the future, or retrieving data stored in the command receiving device 120 about programs that have previously been scheduled. The command sending terminal 110 transmits the commands to the command receiving device 120 via a communications link 115. The command receiving device 120 is coupled to the communications link via a network interface, which may include, for example, a modem. The command receiving device 120 interprets the commands received from the command sending terminal 110 to control the recording device 130. In one embodiment, the recording device 130 is separate from the command receiving device 120, and the command receiving device 120 sends instructions to the recording device 130 via a control interface. The control interface may include, but is not limited to, an infrared transmitter, or Bluetooth transmitter. In an alternate embodiment, the command receiving device 120 and recording device 130 are integrated into a single component, illustrated by a dotted line 140 around the command receiving device 120 and the recording device 130.

In another embodiment, a user communicates with a recording device from a remote location by means of an Internet or wireless communications connection. A user browses a Web or Wireless Access Protocol (WAP) page hosted by a service provider to retrieve the latest television program timetable and selects one or more programs to be recorded. The service provider sends commands over a communications network, such as a mobile telephone network or the Internet, to a command receiving terminal associated with the recording device. In one embodiment, the command receiving terminal is connected to a telephone line, and the selection of programs by the user results in the service provider generating a telephone call to the command receiving terminal to transmit the commands to control the recording device.

As described above, the command receiving device 120 transmits commands to the recording device 130 to enable a user to control the recording device from a remote location. There are a number of implementations for a user at the command sending terminal 110 to query for recording information. In the first implementation, no duplex communication between command receiving device 120 and recording device 130 is required. The command receiving device 120 simply reports the recording information stored in its internal memory by “voice segment” technology. In the second implementation, command receiving device 120 has to retrieve information from the recording device 130, as described in this paragraph. Hence, the information reported to the user is the information stored in the recording device 130.

In one implementation, the system 100 provides a duplex communication path between the command receiving device 120 and the recording device 130. The duplex communication path enables a user to query the recording device 130 for information such as a currently selected channel, time, programmed start and end times, and remaining recording time, for example. A user queries the recording device 130 by sending a predetermined sequence of DTMF tones from the command sending terminal 110 via the communication link 115 to the command receiving device 120. The command sending device 120 translates the received DTMF tones into a command recognised by the recording device 130. In one implementation, the translation of DTMF tones is based on a set of commands programmed into the command receiving device 120 during an initial learning mode. Alternatively, the command receiving device 120 is pre-programmed with a set of commands understood by the recording device 130. In one implementation, a processor in the command receiving device 120 translates the received DTMF tones into commands recognised by the recording device 130, using a database look-up table.

In one implementation, the command receiving device 120 has an associated database, not shown, that stores pre-recorded voice segments that allow voice messages to be played back to the command sending terminal 110. For example, the command receiving device 120 has an associated database that stores pre-recorded voice segments corresponding to each number from 1 to 59. Other voice segments may include “am”, “pm”, “on”, and “off”. The command receiving device 120 concatenates the voice segments to construct, for example, a time to be played back to the command sending terminal 110. For example, a programmed recording time of the recording device is set to start recording at 11:15 am. A user wanting to establish what time the recording device is programmed to start recording uses the command sending terminal 110 to establish a connection to the command receiving device 120. After entering any appropriate user identification code, the user enters a code sequence to retrieve the programmed start time. The code sequence may be a predetermined code sequence, or may be a number pressed in response to a menu, such as a voice menu, played from the command receiving device 120. The command receiving device 120 receives the code sequence, and translates the code sequence to one or more commands understood by the recording device 130 relating to stored programming data. The recording device 130 responds to the one or more commands, and presents the programmed start time, corresponding to 11:15 am, to the command receiving device 120. The command receiving device 120 receives the programmed start time and, in this embodiment, concatenates the voice segments “11”, “15” and “am” to play back to the command sending terminal 110. Various other voice segments may, of course, also be stored to improve the user-friendliness of the system 100. For example, a segment of “The programmed start time is” may be played before the concatenated programmed start time segments are played. Further, voice segments may be recorded in multiple languages, with a user selecting a language when configuring the command receiving device 120.

In the embodiment described above in which the command receiving device 120 and the recording device 130 are provided as an integrated component 140, the command receiving device 120 and the recording device 130 exchange information via an internal bus, or the like. In another embodiment, the command receiving device 120 and the recording device 130 are not integrated into a single component, and the command receiving device 120 and the recording device 130 exchange information using a communication path, such as an infrared communication path or Bluetooth, using a predetermined communication protocol.

No special protocol is required for the duplex communication between command receiving device 120 and the recording device 130. There are lots of wireless protocol standards available in the industry such as IrDA, Bluetooth, WiFi, etc. that can fulfil the purpose. Many solutions including firmware drivers and hardware modules are provided in the market for the above industrial communication standards. The recording device simply incorporates a receiver.

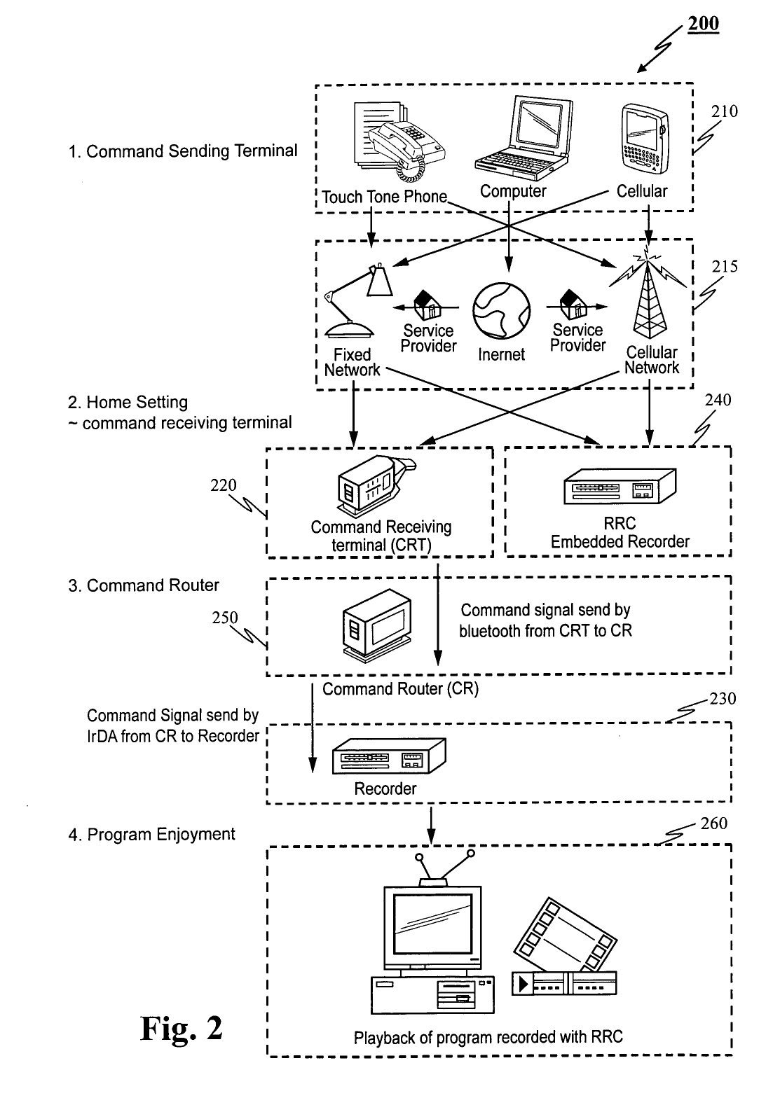

FIG. 2 is a schematic block diagram representation of a system 200 for remote operation of a recording device. The system includes a command sending terminal 210. As indicated above, the command sending terminal 210 may be implemented using, for example, a touch tone telephone, a mobile telephone, a wireless communications device, or a computer. A user enters commands on the command sending terminal 210, and the commands are transmitted via a communications link 215, such as a fixed communications network, the Internet, a wireless communications network, or a combination thereof, for example, to either a separate command receiving terminal 220 or an integrated unit 240 including a command receiving terminal and a recording device.

The command receiving terminal 220 and integrated unit 240 are each equipped with an interface for connecting to the communications link 215 on which signals are transmitted from the command receiving terminal 210. In one implementation, the commands sent to the command receiving terminal 220 from the command sending terminal are preferably implemented using DTMF tones. The DTMF tones include, for example, representations of digits 0 to 9, as well as the special keys * and #. In one implementation, a user operating the command sending terminal 210 generates DTMF tones in response to an automated menu generated by the command receiving terminal 220. The automated menu generated by the command receiving terminal 220 may include, for example, an authentication prompt for a user identifier. Access to other menus is only enabled if the user enters a correct Personal Identification Number (PIN) in response to the authentication prompt. It will be appreciated by a person skilled in the art that other command signals may equally be practised without departing from the spirit and scope of the invention.

The embodiments of the invention apply to any voice network, whether it is an IP-based network or circuit-switched telephony transmission lines.

In the case in which an integrated unit 240 is utilised, the command receiving terminal embedded within the integrated unit 240 receives the commands transmitted from the command sending terminal 210 and utilises those received commands to control the recording device within the integrated unit 240. In one such embodiment, the integrated unit 240 is coupled to a fixed telephone line connection to receive incoming commands from the command sending terminal 210. In an alternate embodiment, the integrated unit 240 is coupled to a data connection of a communications service provider to receive commands from the command sending terminal 210.

In the alternate embodiment in which a separate command receiving terminal 220 is provided, the command receiving terminal 220 receives the commands from the command sending terminal 210 and utilises those received commands to control an associated recording device 230. In the embodiment shown in FIG. 2, the command receiving terminal 220 controls the recording device 230 via a command router 250. The command receiving terminal 220 sends command signals to the command router 250, and the command router 250 in turn transmits the command signals to the recording device 230.

In one embodiment, the command router 250 communicates with the recording device 230 via a wireless communications path, such as IrDA (Infrared Data Association) or Bluetooth. In many situations, the positioning of a command receiving terminal 220 within a building may be restricted as a result of a connection to the communications network on which commands are received from the command sending terminal 210. The command router 250 is located close to the command receiving terminal 230, and communicates over a wireless communication path with the recording device 230. The wireless communications path between the command router 250 and the recording device 230 allows a user to position the recording device 230 with much greater flexibility. In an alternate implementation, the command router 250 is physically coupled to the recording device 230. The physical coupling may be implemented, for example, using coaxial cable, optical fibre, or other means as would be readily apparent to a person skilled in the relevant art.

In another embodiment, the command router 250 is compatible with the G-code encoding system. The command router 250 receives commands from the command sending terminal 210 via the command receiving terminal 220, translates those commands to a G-code compatible format, where necessary, and then transmits the G-code information to a G-code compatible recording device 230. The G-code information may include, for example, On/Off signals, launch of G-code prompt signal, “enter” signal, and one or more numbers in the range 0 . . . 9.

The recording device 230 is implemented using a VCR, DVD, hard-disk recorder, writable CD, flash memory, or other storage medium, and records the programs selected by the user. The recorded programs are then available for playback at a later time on an appropriate display 260.

As described above, one implementation utilises a command receiving terminal coupled to a telephone connection for receiving commands from a remotely located command sending terminal. It is desirable to minimise the number of telephone connections in a household. Accordingly, a further embodiment provides a command receiving terminal combined with a voicemail system. Such a combined system will be referred to as a Voicemail and Video Recorder Remote Control (VVRC). The VVRC is connected to a telephone connection.

An incoming telephone call received by the VVRC generates a normal ring tone that allows an occupant present in the building to answer the incoming call. This ensures that ordinary incoming telephone calls can be received when a user is at home. When a user is not home to receive an incoming call, the ring tone is played for a predetermined ringing time. The predetermined ringing time may be set at the factory, or may be a user-definable setting. The predetermined ringing time may be set, for example, to ten seconds, twenty seconds, or thirty seconds, or any other desired timeframe, and may be monitored by a timer or other processing device.

When the predetermined ringing time has expired, the voicemail system answers the call. The voicemail system plays a pre-recorded message to the caller, and preferably asks the caller to leave a voicemail message to be retrieved by the user at a more convenient time.

If the incoming call is a normal voice call, the caller chooses whether to leave a voicemail message, before terminating the call. However, if the incoming caller is the user accessing the VVRC from a remote command sending terminal, such as a mobile telephone, the user enters an appropriate identifier and is then able to retrieve any recorded voicemail messages. The identifier required for authorisation of the user may be a Personal Identification Number (PIN) or other such identifier as would readily be understood by a person skilled in the art. The command receiving terminal recognises the authorisation identifier and activates a recording mode. Having entered the appropriate identifier, a user is also able to access control to the VVRC, by selecting an appropriate sequence of keystrokes on the command sending terminal. The sequence of keystrokes may immediately identify an action to be implemented by the VVRC, or alternatively the keystrokes may be in direct response to a menu played by the command receiving terminal. For example, pressing the sequence “#9#” may indicate that the VVRC is to record immediately the program currently being broadcast on channel 9. For a G-code compatible VVRC, the user can enter the G-code sequence to control the VVRC. In response to the received commands, the VVRC controls a recording device, which may be integrated into the VVRC, or may be located separately from the VVRC.

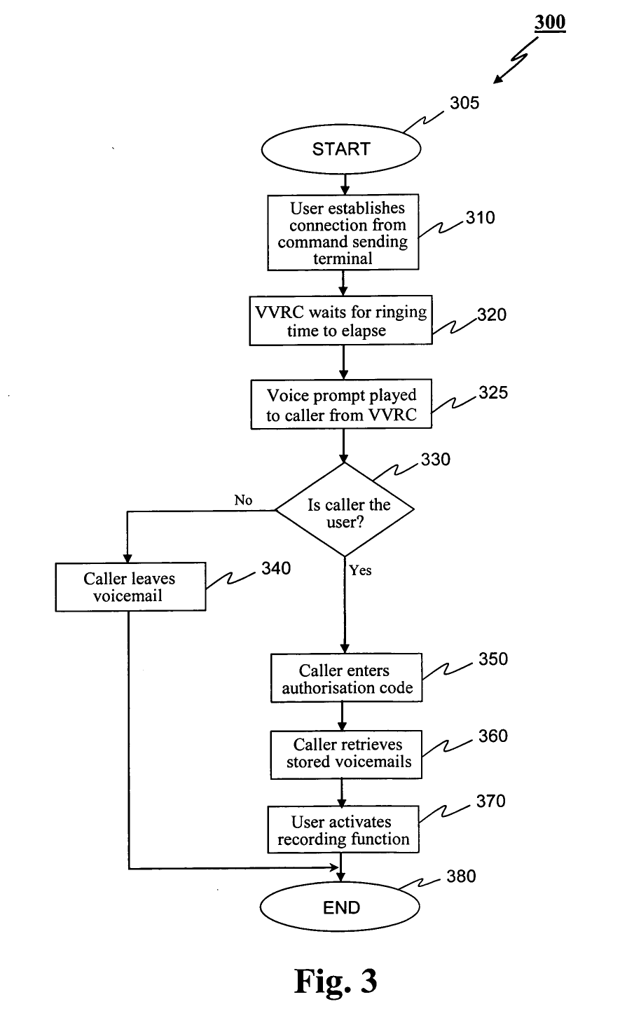

FIG. 3 is a flow diagram of a method of operation 300 of the VVRC from a command sending terminal. The method 300 begins at a start step 305 and progresses to step 310, in which a user utilises the command sending terminal to establish a connection with the VVRC. In this example, the connection is a telephone call from the command sending terminal to the VVRC, wherein the VVRC is connected to a telephone network or is adaptable to received incoming telephone calls over a communications network, such as telephone calls utilising Voice over Internet Protocol over the Internet. At a next step 320, the VVRC waits a predetermined ringing time before answering the incoming call. This allows a person located within close proximity of the VVRC to answer the incoming call manually.

Control passes to step 325, in which the VVRC provides a pre-recorded voice prompt asking the caller to leave a voicemail message for the householder. The voice prompt is optionally configured to match a user's preferred language. The VVRC voicemail system may provide up to eight or more different accounts corresponding to different members of the household in which the VVRC is located. Control passes to decision step 330, which determines whether the caller is the user. If the caller is not the user, No, control passes to step 340, in which the caller leaves a voicemail message utilising a voicemail system incorporated within the VVRC. The voicemail message is stored on magnetic tape, flash memory, or other storage medium. Control passes from step 340 to an End step 380, and the method terminates.

Returning to step 330, if the caller is the user, Yes, control passes to step 350 and the caller enters an authorisation code to identify the user to the VVRC as an authorised user. Control passes to step 360, in which the user is able to retrieve recorded voicemails from other users by entering an access code, which may include, for example, but is not limited to, a predetermined sequence of one or more numbers. Control then passes to step 370, in which the user activates the recording function, by entering an activation code, for example, as described above with respect to the access code, the activation code may include, for example, but is not limited to, a predetermined sequence of one or more numbers. The sequence of numbers for the access code and activation code are preferably provided by sending DTMF tones from the command sending terminals. In step 370, the user provides commands for the VVRC to control a recording device. The commands may be provided directly by the user, or may be in response to one or more menus provided by the VVRC. Control passes from step 370 to the terminating step 380.

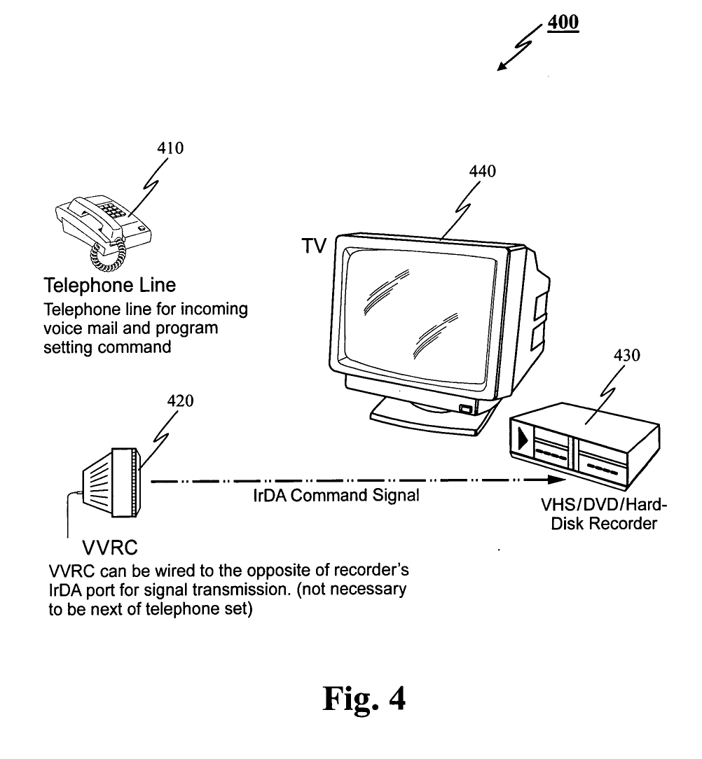

FIG. 4 is a schematic block diagram representation of a receiving system 400 incorporating a VVRC. The receiving system 400 includes a fixed line telephone connection 410. The fixed line telephone connection 410 is coupled to a VVRC 420, which allows incoming voice calls to be answered by a user and optionally provides voicemail capability to allow incoming callers to leave messages for a user when the user is not at home or is unable or unwilling to answer the incoming call. The VVRC 420 is coupled to a recording device 430. In the embodiment shown, the coupling is implemented using an infrared wireless communications link. Thus, the VVRC 420 is located such that a direct line of sight is provided to the recording device 430. In an alternate embodiment, the coupling is implemented using Bluetooth, and the VVRC does not need to be located in a direct line of sight from the recording device 430. The recording device is optionally coupled to a display device 440, such as a television or display monitor.

The VVRC 420 is capable of learning signals from recording devices from different manufacturers. A learning mode is provided on the VVRC 420, wherein the VVRC 420 learns commands associated with a recording device owned by a user. The VVRC 420 acts as a universal remote control, as would be readily understood by a person skilled in the art. For example, the learning mode may be implemented using infrared signals from an existing infrared remote control associated with the recording device. The user enters a code into the VVRC indicating that the next infrared signal to be received corresponds to a “1”, for example. The user then presses the “1” button on the existing remote control associated with the recording device while directing the existing remote control towards the VVRC. The VVRC receives a signal corresponding to “1” and stores the signal in memory. Thus, the VVRC has learnt the signal for “1” recognised by the recording device. The learning procedure is then repeated for other relevant keys and functions of the recording device.

In another example, the VVRC 420 learns signals associated with a recording device by receiving audible tones over a telephone line, while operating in a learning mode. In a further example, a user enters a set of codes into the VVRC 420 to establish a set of operating commands associated with the recording device. For example, the set of operating commands may be selected from a database of operating commands in a memory of the VVRC 420.

A user optionally configures the VVRC 420 to operate in a personalised manner. In one implementation, the VVRC includes a programming module and a voice recording module. The programming module relates to functions associated with controlling a recording device. Accordingly, configuring the programming module may include, for example, teaching the programming module one or more commands associated with an external recording device, as described above. Configuring the programming module may also include programming a user identifier, such as a PIN, to confirm that a user calling the VVRC is authorised to activate control of the recording device. Commands and user information may be stored in a memory of the VVRC 420.

Configuring the voice recorder may include such functions as programming a user identifier and recording a message to be played when the VVRC receives an incoming call. The respective user identifiers of the programming module and the voice recorder may, in one implementation, be the same PIN, and may be configured in a single operation, rather than in two distinct operations. The user identifier associated with the voice recorder enables an authorised user to retrieve recorded messages from the VVRC.

The programmer may be separate. The boundary between the programmer and voice recorder is functional; during implementation, the modules can share resources such as memory, power control, etc.

In one embodiment, a VVRC is provided that includes a connection for a telephone line, an IrDA port for communicating with a recording device, a speaker and microphone for recording and playback of voicemail messages, and a keypad. The VVRC also optionally includes a display to indicate a present status. A simple display includes one or more LEDs, whilst a more comprehensive display is implemented using a liquid crystal display (LCD) screen for receiving and displaying commands and program recording schedules. In an alternate implementation, the display is a grey scale display with a plurality of selection buttons, wherein the display is able to present information relating to prompts, status indications, and selection options. The keypad preferably includes a full numeric keypad of digits 0 . . . 9, #, *, one or more master reset buttons, a Learn toggle switch, a program switch, and keys for controlling the voicemail functionality. The voicemail control keys may include, for example, playback, date and time keys, a save key, and a delete key. The VVRC preferably includes a memory for storing commands and user information, and a processor for processing data exchanged between the other components.

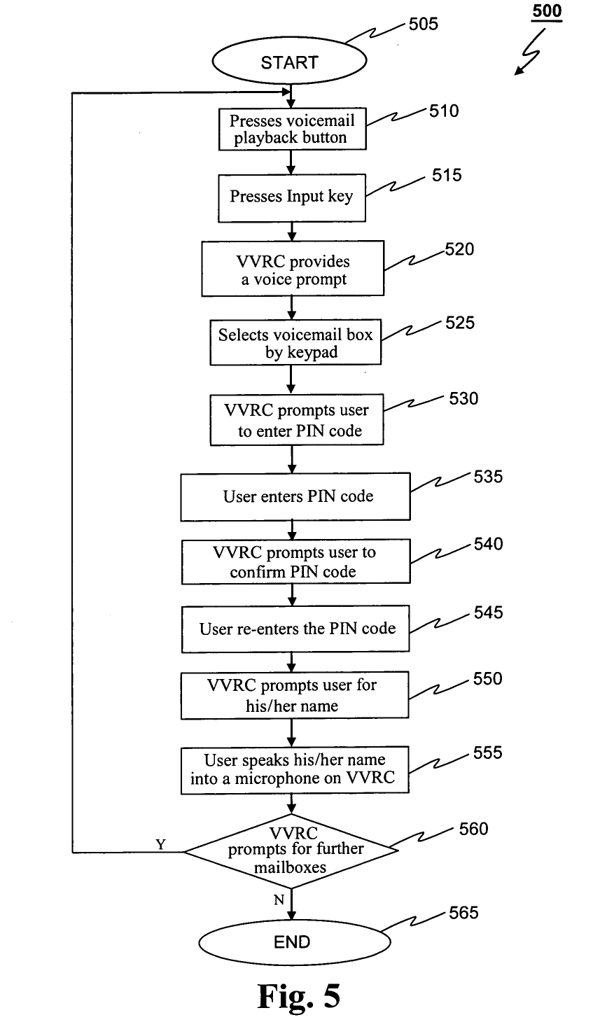

FIG. 5 is a flow diagram of a method of setting up a user profile associated with a VVRC according to an embodiment of the present disclosure. The method 500 begins at a Start step 505, and proceeds to step 510, in which a user presses a voicemail playback button. In the next step 515, the user presses an Input key, and control passes to step 520, in which a voice prompt is provided by the VVRC. The voice prompt informs the user of voicemail boxes that are available. In step 525, the user selects an available voicemail box by entering a corresponding code on a keypad of the VVRC.

Control passes to step 530, in which the VVRC prompts the user to enter a PIN of a predetermined length. In step 535, the user enters a PIN and presses the # key to indicate the end of the PIN. Control passes to step 540, in which the VVRC prompts the user to confirm the entered PIN. Accordingly, in the next step 545, the user re-enters the PIN from step 535. Control passes to step 550, in which the VVRC prompts the user for his/her name. In step 555 the user speaks his/her name into a microphone on the VVRC and the VVRC records the name for playback. In the next step 560, the VVRC prompts the user to determine whether further mailboxes are to be set up. If Yes, control returns to step 510. If No, control passes to an End step 565 and the method terminates. It will be appreciated by a person skilled in the art that variations on the method 500 are possible, without departing from the spirit and scope of the invention. Further functionality may include deleting one or more voicemail boxes, and re-recording a name or message.

One embodiment of a VVRC according to an embodiment of the present disclosure provides automatic set up of the VVRC. A user accesses an Internet website associated with the VVRC provider, and enters an activation code and a device code corresponding to a recording device that is to be controlled by the VVRC. The device code may be included in literature provided with the VVRC, or may be provided on an Internet website, or other appropriate publication. The user then enters a telephone number to which the VVRC is connected. The VVRC provider establishes a call to the VVRC and uploads any required data to program the VVRC. Alternatively, the user provides an Internet Protocol (IP) address for the VVRC if the VVRC is connected to a data link, and the VVRC provider transmits any required data across the data link to program the VVRC. The user may also contact the VVRC provider by telephone and provide the required information. The VVRC provider then establishes a connection to the VVRC, via a telephone call or data link, and uploads the required data.

It is also possible to manually program the VVRC to communicate with a user's recording device. This may be necessary if the recording device is not on a list of supported devices published by the VVRC provider. A user presses a “Learn” button on the VVRC. The VVRC prompts the user to press buttons on an infrared remote control associated with the recording device. An infrared port on the VVRC receives signals transmitted from the remote control in response to the prompts, and thus learns the protocol for communicating with the recording device. The prompts presented by the VVRC typically include all of the numeric keys, a Power On key, and a Select key. Other functionality and keys may be supported, depending on the specific recording device. To terminate the learning process, the user presses the “Learn” button.

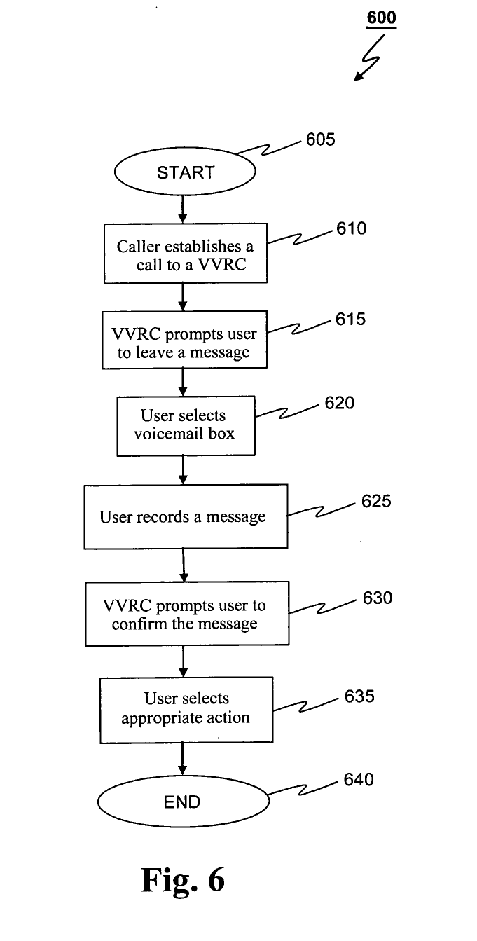

FIG. 6 is a flow diagram of a method 600 of leaving a voicemail message on a VVRC according to an embodiment of the present disclosure. The method begins at a Start step 605 and proceeds to step 610, in which a caller establishes a call to a VVRC connected to a telephone line. In the next step 615, the VVRC plays a recorded message prompting the caller to leave a message. The recorded message recites names associated with voicemail boxes that have been set up, and indicates a number that the caller should press to select a specific mailbox. In step 620, the user selects a voicemail box, and records a message in step 625. At step 630, the VVRC prompts the user to: (i) confirm the message by pressing “1”; (ii) playback the message by pressing “2”; (iii) re-record the message by pressing “3”; (iv) or mark the message urgent by pressing “4”. The user selects the appropriate action in step 635 and the method terminates at an End step 640.

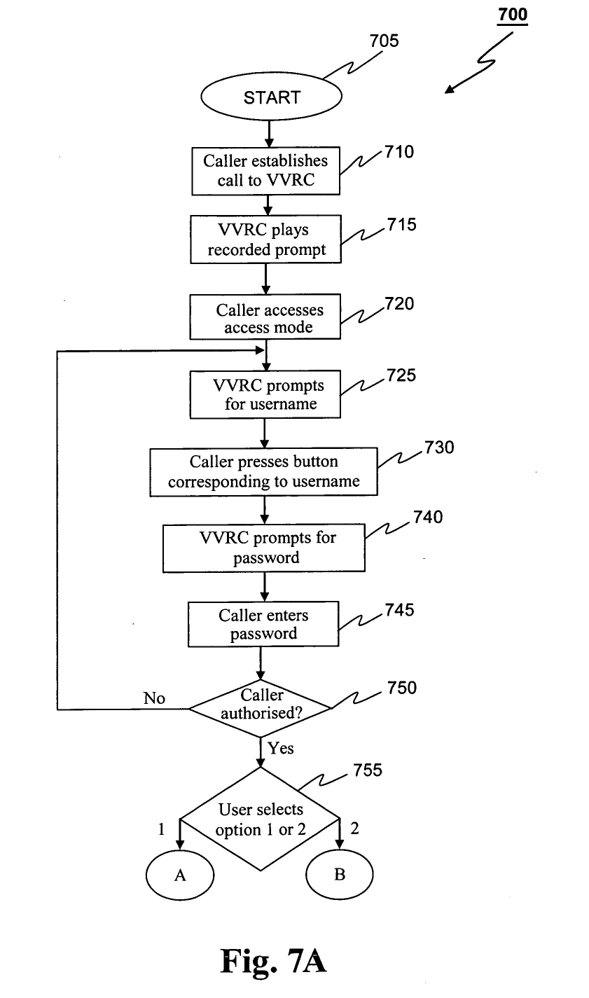

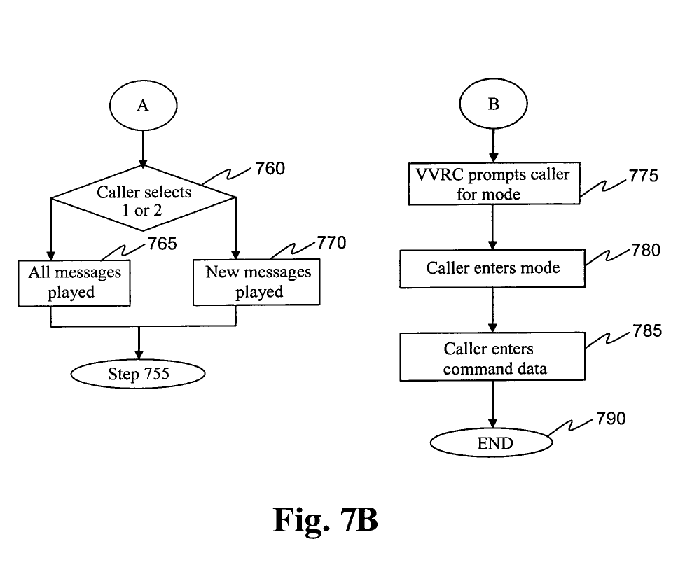

FIGS. 7A and 7B are a flow diagram of a method 700 of a caller establishing a call to a VVRC according to an embodiment of the present disclosure, in order to control a recording device. The method begins at a Start step 705 and proceeds to step 710, in which the caller establishes a call to the VVRC. In step 715, the VVRC plays a recorded prompt to the caller. In the next step 720, the user presses the “*” key for a predetermined access time, such as 2 seconds, to access a user mode for the VVRC. Control passes to step 725, in which the VVRC provides a prompt that includes a list of usernames with associated numbers. The caller presses the number associated with his/her username in step 730, and in step 740 the VVRC prompts the caller to enter a password. In step 745 the caller enters the password, and in step 750 the VVRC determines whether the caller is an authorised user. If the caller is not an authorised user, No, control returns to step 725. If the VVRC determines that the caller is an authorised user at step 750, Yes, control passes to step 755, in which the VVRC prompts the caller to initiate one of the following options: (i) listen to voicemail (press 1); or (ii) program a video recording (press 2).

If the caller wants to retrieve any stored voicemail messages, the user presses the button 1, and control passes to step 760, in which the VVRC prompts the user to hear: (i) all messages (1); or (ii) new messages (2). If the user selects all messages, 1, control passes to step 765 and the VVRC plays all recorded voicemail messages according to a predetermined sequence. The predetermined sequence typically plays the oldest messages first, followed by more recent messages, with messages marked URGENT played at the beginning. If at step 760 the user selects new messages, 2, control passes to step 770 and the VVRC plays only new messages that have not previously been heard by the caller. Having heard the messages, the caller has the usual options of saving, deleting, or replaying any one or more of the voicemail messages. For the sake of clarity, these steps are not shown in the flow diagram of FIG. 7. Control passes from each of steps 765 and 770 to step 755. The caller may hang up at any time and terminate the call.

Returning to step 755, if the caller wants to program a video recording, the caller presses 2 and control passes to step 775, which provides a voice prompt to the caller. In the next step 780, the caller selects a manual mode, 1, or a G-code mode, 2. Control passes to step 785, and the caller enters appropriate command data. If the caller selected the manual mode at step 780, the command data includes a channel, start time, and end time for a program that the caller wants to record. Other command data may optionally be included, such as whether the program is to be recorded in long play mode or short play mode, for example. If the caller selected the G-code mode at step 780, the command data will correspond to a G-code associated with a program to be recorded. Control passes to step 790 and the method terminates.

Once the VVCR receives commands from a user, the VVCR sends a command to turn on a recording device, generates and transmits one or more commands to activate a programming mode of the recording device, and transmits programming data to the recording device. The VVCR then turns off the recording device and initiates a timer to execute the scheduled program recording.

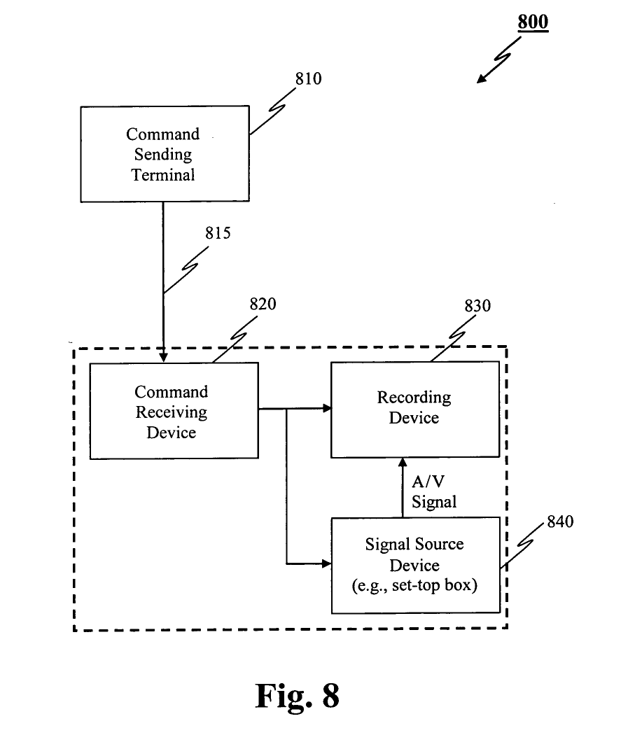

FIG. 8 shows a schematic block diagram representation of a remotely operable recording system 800. The recording system 800 includes a command sending terminal 810, a command receiving device 820, a recording device 830 and a signal source device 840. The signal source device 840 provides an audio and/or video signal to the recording device 830. The signal source 840 may include, for example, a television, a set-top box, a video camera, and a television tuner. In one embodiment, the signal source device 840 is a set-top box providing a signal from a pay television service provider.

As described above with respect to FIG. 1, a user is able to control the recording device 830 from a remote location by utilising the command sending terminal to establish a communication link 815 to the command receiving device 820 using a communication network to which each of the command sending terminal 810 and the command receiving device 820 are connected. The command receiving device 820 communicates with the recording device 830 in the manner described above. The user sends commands, preferably in the form of DTMF tones, from the command sending terminal 810 to the command receiving device 820 to control the recording device 830.

In the system 800, the signal source device 840 is connected to the recording device 830. The signal source device 840 is coupled to an external service provider, not shown, and provides an audio/visual (A/V) signal to the recording device 830. In the system 800, the command receiving terminal 820 is programmed with commands for controlling the recording device 830 and the signal source device 840. The commands may be learnt from existing remote controls associated with the recording device 830 and the signal source device 840, respectively. Alternatively, the commands may be pre-programmed into a memory of the command receiving device 820. In another implementation, some of the commands are pre-programmed into the command receiving device 820 and some of the commands are learnt from one or more remote controls associated with the recording device 830 and the signal source device 840. Thus, the command receiving device 820 is able to control either one or both of the recording device 830 and the signal source device 840 by transmitting the programmed commands to the recording device 830 and the signal source device 840 in response to user commands transmitted from the command sending terminal 810, enabling a user to control recording of programs from the signal source device 840 using the recording device 830. Thus, the recording device 830 and signal source device 840 are electronic devices controlled by the command receiving device 830.

A conventional standard video cassette recorder can only be scheduled to record a preset channel on the signal source device. In other words, it is impossible to record a sports programme on one channel and then later a documentary in another channel. The embodiments of the invention can solve this problem with the capability to control both the signal source device and recording device.

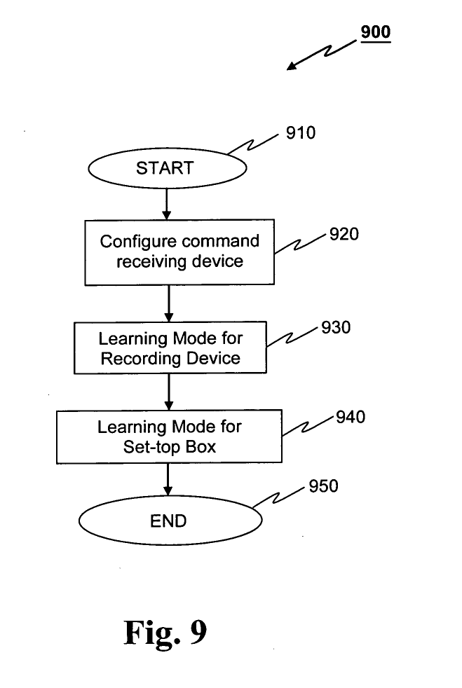

FIG. 9 is a flow diagram illustrating a method of setting up the remotely operable recording system 800. FIG. 9 begins at a Start step 910 and proceeds to step 920, in which a user configures the command receiving device 820. Configuring the command receiving device 820 may include, for example, but is not limited to, setting a date and time of the command receiving device 820, and entering and confirming an authorisation code. The authorisation code may take the form of a PIN or a password, for example. The password may include a number of tones or may be implemented using voice recognition software, for example. Other authorisation codes may equally be practised without departing from the spirit and scope of the invention.

Control passes from step 920 to step 930, in which the command receiving device 820 is placed in a learning mode for commands associated with the recording device 830. The commands may include, but are not limited to, turning the recording device 830 on and off, selecting channels, record start, record end, and programming commands. As described above, the learning mode may include receiving infrared commands from one or more existing remote controls associated with the recording device 830. The learning mode may also include receiving commands directly from the user, based on information provided by the manufacturer of the command receiving device 820 or the manufacturer of the recording device 830. The learning mode may further include activating a set of one or more commands pre-programmed into the command receiving device 820 by identifying a type of recording device with which the command receiving device 820 is to communicate.

Control passes to step 940, in which the command receiving device 820 is placed in a learning mode for commands associated with the signal source device 840. The signal source device commands may include, but are not limited to, turning the signal source device 840 on and off, and selecting channels. As described above, the learning mode may include receiving infrared commands from one or more existing remote controls associated with the signal source device 840. The learning mode may also include receiving commands directly from the user, based on information provided by the manufacturer of the command receiving device 820 or the manufacturer of the signal source device 840. The learning mode may further include activating a set of one or more commands pre-programmed into the command receiving device 820 by identifying a type of signal source device with which the command receiving device 820 is to communicate.

Having configured the command receiving device 820 to operate with each of the recording device 830 and the signal source device 840, the initialising method is complete, so control passes from step 940 to an End step 950 and the method 900 terminates. It will be appreciated by a person skilled in the art that one or more of the steps of the method 900 may equally be performed in parallel or in a different sequential order.

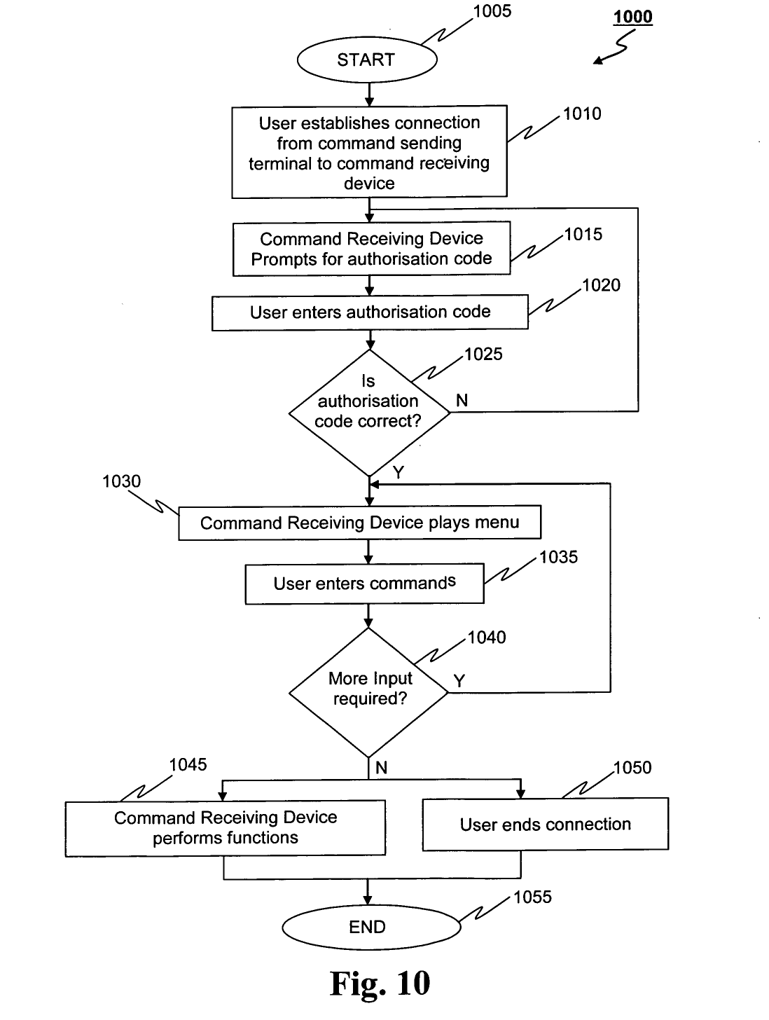

FIG. 10 is a flow diagram of a method 1000 for remotely programming the recording device 830 by utilising the command receiving device 820. The method 1000 begins at a Start step 1005 and proceeds to step 1010, in which a user utilises a command sending terminal 810 to establish a connection to the command receiving device 820 via a communications network. In step 1015, the command receiving device 820 prompts the user for an authorisation code. As described above, the command receiving device 820 may optionally include a voicemail recording system, in which case the prompt for the authorisation code may follow one or more other prompts relating to recording or playback of voicemail messages.

Control passes from step 1015 to step 1020, in which the user enters the authorisation code using the command sending terminal 810. The next step 1025 determines whether the authorisation code is correct. If the authorisation code is not correct, No, control returns to step 1015 and the command receiving device 820 again prompts the user for the correct authorisation code. However, if at step 1025 the authorisation code is correct, Yes, control passes to step 1030, in which the command receiving device plays a menu to the user via the command sending terminal 810.

Control passes to step 1035, in which the user sends commands from the command sending terminal 810 to the command receiving device 820 in response to the menu played in step 1030. The commands may include, for example, selecting a recording date, recording channel, recording start time, and recording end time. The recording channel may be selected from one or more channels received by an internal tuner of the recording device 830. Alternatively, the recording channel may be selected from one or more channels presented by the signal source device 840. In one implementation, a user enters a prefix before a channel number to differentiate between the recording device channels and the signal source device channels.

Control then passes to decision step 1040, which determines whether further input is required. If further input is required, Yes, control returns to step 1030. However, if at step 1040 further input is not required, No, control passes to each of steps 1045 and step 1050. In step 1045, the command receiving device 820 executes the commands entered by the user in step 1035. It will be appreciated that execution of the commands may take some time, particularly if the user has programmed the command receiving device 820 to activate the recording device 830 for some time in the distant future. Control passes from step 1045 to an End step 1055 and the method 1000 terminates. In step 1050, the user terminates the connection from the command sending terminal 810 to the command receiving device 820. Control passes from step 1050 to the End step 1055 and the method 1000 terminates.

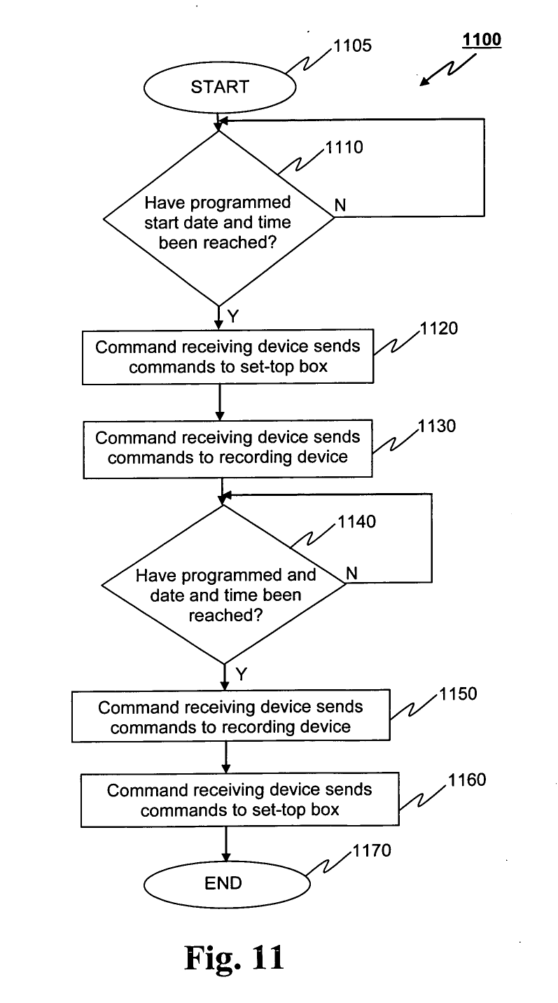

FIG. 11 is a flow diagram of a method 1100 of activating remote recording utilising the recording system 800 of FIG. 8. As described above with reference to FIGS. 9 and 10, a user initialises the command receiving device 820 and then programs the command receiving device 820. In this example, the user has programmed the command receiving device 820 to record a program provided by the signal source device 840 on Channel 33 from 8:30 pm to 10:30 pm on Thursday night, by entering appropriate commands in step 1035 of FIG. 10 above.

The method 1100 begins at a Start step 1105 and proceeds to step 1110, in which the command receiving device determines whether the date and time configured in step 920 of FIG. 9 corresponds to the programmed start date and time. If the programmed start data and time have not been reached, No, control returns to step 1110. If, however, the programmed start date and time have been reached, control passes from step 1110 to step 1120, in which the command receiving device 820 sends control commands to the signal source device 840. The control commands may include, for example, a turn on command and channel selection command to select a channel corresponding to a programmed recording channel, Channel 33. Control then passes to step 1130, in which the command receiving device 820 sends control commands to the recording device 830. The commands sent to the recording device 830 may include, for example, a turn on command, and start recording command. The commands may also include a channel select command to ensure the correct channel is selected on the recording device 830 to receive the A/V input from the signal source device 840.

Control passes from step 1130 to another decision step 1140, in which the command receiving device 820 determines whether a programmed end date and time have been reached. If the programmed end date and time have not been reached, No, control returns to step 1140. However, if the programmed end date and time have been reached, Yes, control passes from step 1140 to step 1150, in which the command receiving device 820 sends control commands, such as a stop recording command and a turn off command, to the recording device 830 to terminate the recording and turn the recording device 830 off. Control then passes to step 1160, in which the command receiving device 820 sends control commands to the signal source device 840 to turn the signal source device 840 off. Control passes to step 1170 and the method 1100 terminates. It will be appreciated by a person skilled in the art that one or more of the steps of the method 1100 may equally be performed in parallel or in a different sequential order without departing from the spirit and scope of the invention.

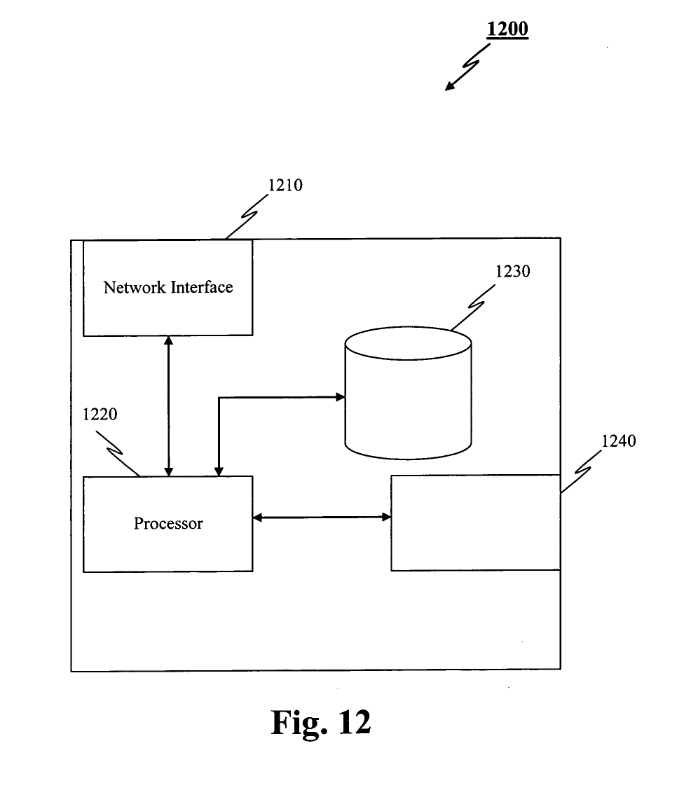

FIG. 12 is a schematic block diagram representation of a command receiving terminal 1200 for controlling an electronic device that is operable using wirelessly transmitted commands. The command receiving terminal 1200 includes a network interface 1210, a processor 1220, a memory 1230, and a control interface 1240. The processor 1220 is coupled to each of the network interface 1210, the memory 1230, and the control interface 1240.

The network interface 1210 is adapted to couple the command receiving terminal 1200 to a communications network, so as to receive commands transmitted over the communications network from a remotely located command sending terminal (not shown), as described above. In one implementation, the communications network is a telecommunications network. Commands received by the network interface 1210 are passed to the processor 1220. Where necessary, the processor 1220 translates the received commands, using a set of control commands stored in the memory 1230, to control commands recognised by the electronic device that is to be controlled.

The processor 1220 passes the control commands to the control interface 1240 to be transmitted to the electronic device. In one implementation, the control interface 1240 includes a wireless transmitter, such as an infrared or Bluetooth transmitter, for transmitting the control commands directly to the electronic device. In another implementation, the control interface is coupled to a router that is adapted to establish a wireless communications link with the electronic device. The control interface transmits the control commands to the router, and the router transmits the control commands to the electronic device via the wireless communications link.

In a further embodiment, the command receiving terminal 1200 includes answering machine functionality. In such an embodiment, the command receiving terminal optionally includes a speaker for playing recorded voicemail messages, and a microphone for recording a user message. Messages may be stored in the memory 1230, or another recording medium provided for that purpose, as would be readily understood by a person skilled in the art.

The aforementioned preferred method(s) comprise a particular control flow. There are many other variants of the preferred method(s) which use different control flows without departing the spirit or scope of the invention. Furthermore, one or more of the steps of the preferred method(s) may be performed in parallel rather than sequentially.

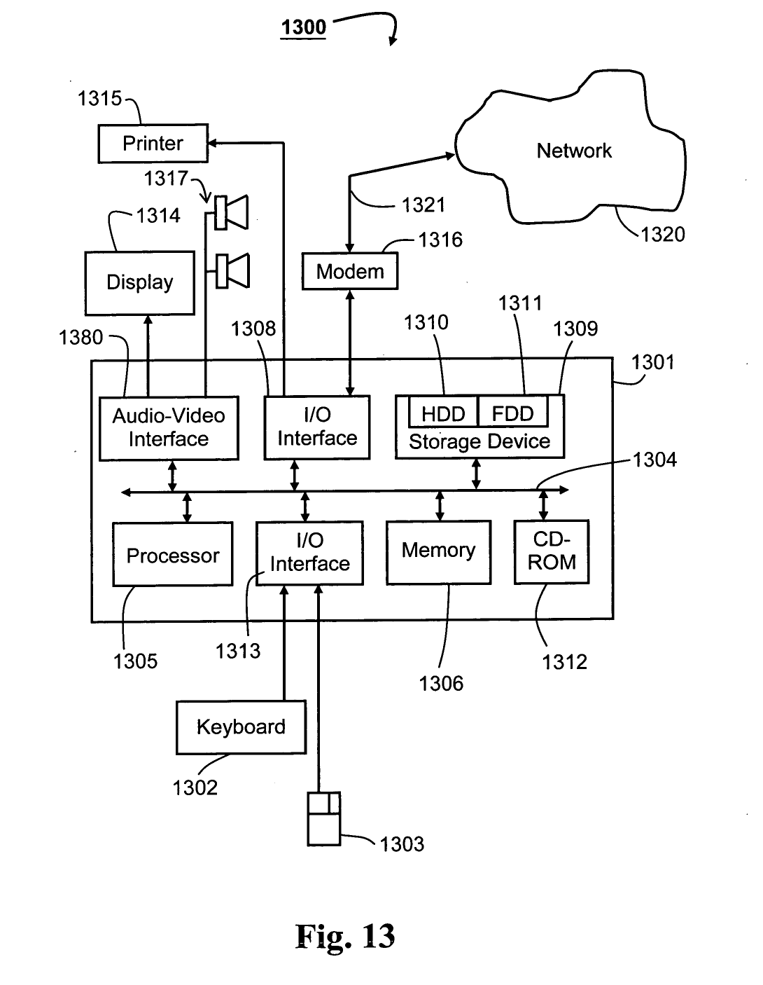

The method of remotely operating a recording device is preferably practised using a command receiving device implemented embodied as a general-purpose computer system 1300, such as that shown in FIG. 13, wherein the processes of FIGS. 1 to 12 may be implemented as software, such as an application program executing within the computer system 1300. In particular, the steps of receiving commands, preferably in the form or DTMF tones, and translating the commands into commands understood by the recording device are effected by instructions in the software that are carried out by the computer. The instructions may be formed as one or more code modules, each for performing one or more particular tasks. The software may also be divided into two separate parts, in which a first part performs the remote operation methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for remote operation of a recording device.

The computer system 1300 is formed by a computer module 1301, input devices such as a keyboard or keypad 1302 and mouse 1303, output devices including a printer 1315, a display device 1314 and loudspeakers 1317. A Modulator-Demodulator (Modem) transceiver device 1316 is used by the computer module 1301 for communicating to and from a communications network 1320, for example connectable via a telephone line 1321 or other functional medium. The modem 1316 can be used to obtain access to the Internet, and other network systems, such as a Local Area Network (LAN) or a Wide Area Network (WAN), and may be incorporated into the computer module 1301 in some implementations. The modem 1316 may be utilised in the reception of commands from a command sending terminal. The modem 1316 may also be utilised in sending data to, and optionally receiving data from, the recording device.

The computer module 1301 typically includes at least one processor unit 1305, and a memory unit 1306, for example formed from semiconductor random access memory (RAM) and read only memory (ROM). The module 1301 also includes an number of input/output (I/O) interfaces including an audio-video interface 1307 that couples to the video display 1314 and loudspeakers 1317, an I/O interface 1313 for the keyboard 1302 and mouse 1303 and optionally a joystick (not illustrated), and an interface 1308 for the modem 1316 and printer 1315. In some implementations, the modem 1316 may be incorporated within the computer module 1301, for example within the interface 1308. A storage device 1309 is provided and typically includes a hard disk drive 1310 and a floppy disk drive 1311. A magnetic tape drive (not illustrated) may also be used. A CD-ROM drive 1312 is typically provided as a non-volatile source of data. The components 1305 to 1313 of the computer module 1301, typically communicate via an interconnected bus 1304 and in a manner which results in a conventional mode of operation of the computer system 1300 known to those in the relevant art. Examples of computers on which the described arrangements can be practised include IBM-PCs and compatibles, Sun Sparc stations or alike computer systems evolved therefrom.

Typically, the application program is resident on the hard disk drive 1310 and read and controlled in its execution by the processor 1305. Intermediate storage of the program and any data fetched from the network 1320 may be accomplished using the semiconductor memory 1306, possibly in concert with the hard disk drive 1310. In some instances, the application program may be supplied to the user encoded on a CD-ROM or floppy disk and read via the corresponding drive 1312 or 1311, or alternatively may be read by the user from the network 1320 via the modem device 1316. Still further, the software can also be loaded into the computer system 1300 from other computer readable media. The term “computer readable medium” as used herein refers to any storage or transmission medium that participates in providing instructions and/or data to the computer system 1300 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1301. Examples of transmission media include radio or infra-red transmission channels as well as a network connection to another computer or networked device, and the Internet or Intranets including e-mail transmissions and information recorded on Websites and the like.

The method of remotely operating a recording device may alternatively be implemented in dedicated hardware such as one or more integrated circuits performing the functions or sub functions of receiving commands, transmitting commands, translating commands, and routing commands. Such dedicated hardware may include graphic processors, digital signal processors, or one or more microprocessors and associated memories.

### INDUSTRIAL APPLICABILITY

It is apparent from the above that the arrangements described are applicable to the electronics, entertainment and communications industries.

The foregoing describes only some embodiments of the present invention, and modifications and/or changes can be made thereto without departing from the scope and spirit of the invention, the embodiments being illustrative and not restrictive.

We claim:

1. A command receiving device for controlling an electronic device operable using wirelessly transmitted commands, said command receiving device comprising:
a network interface for coupling to a communications network;
a control interface for coupling to said electronic device;
a memory for storing a set of one or more control commands recognised by said electronic device; and
a processor coupled to the network interface, the control interface, and the memory;
wherein said processor translates at least one command received from said communications network via said network interface to at least one of said control commands, said control interface transmitting said at least one control command to said electronic device to control said electronic device.

2. The command receiving device according to claim 1, wherein said received command is a sequence of one or more dual tone multi-frequency tones.

3. The command receiving device according to claim 1, wherein said communications network is a telecommunications network.

4. The command receiving device according to claim 1, wherein said control interface includes an infrared transmitter for transmitting instructions to said electronic device using an infrared communications link.

5. The command receiving device according to claim 1, wherein said control interface includes a Bluetooth transmitter for transmitting instructions to said electronic device using a Bluetooth communications link.

6. The command receiving device according to claim 1, wherein said control interface is adaptable to receive data from said electronic device.

7. The command receiving device according to claim 1, wherein said control interface effects coupling to said electronic device by means of a wireless communications link selected from the group of wireless communications links consisting of: infrared and Bluetooth

8. The command receiving device according to any one of claims 1 to 7, wherein said electronic device is a recording device.

9. The command receiving device according to claim 8, wherein said recording device is selected from the group of recording devices consisting of: a video cassette recorder, a DVD recorder, a hard-disk drive, and a flash memory recorder.

10. The command receiving device according to any one of claims 1 to 7, wherein said electronic device is a signal source device.

11. The command receiving device according to either 10, wherein said signal source device is selected from the group of signal source devices consisting of: a television, a set-top box, a video camera, and a television tuner.

12. The command receiving device according to claim 1, wherein said command receiving device plays one or more audio prompts to a command sending terminal coupled to said command receiving device via said communications network.

13. The command receiving device according to claim 12, wherein said received command is in response to at least one of said audio prompts.

14. The command receiving device according to claim 13, wherein said audio prompts are selected from a plurality of languages.

15. The command receiving device according to any one of claims 1 to 14, further comprising:
an answering machine providing voicemail facilities.

16. The command receiving device according to any one of claim 15, further comprising:
a keypad for receiving user commands;
a display for indicating a present status of the command recording device and for facilitating programming of said command receiving device; and
a speaker for playing recorded voicemail messages from said memory; and
a microphone for receiving a user message;
wherein said processor is coupled to the keypad, the display, the speaker, and the microphone.

17. A remotely operable system for controlling an electronic device operable using wirelessly transmitted commands, comprising:
an electronic device operable using wirelessly transmitted commands; and
a command receiving terminal including:
a network interface for coupling to a communications network;
a control interface for coupling to said electronic device;
a memory for storing a set of one or more control commands recognised by said electronic device; and
a processor coupled to the network interface, the control interface, and the memory;
wherein said processor translates at least one command received from said communications network via said network interface to at least one of said control commands, said control interface transmitting said at least one control command to control said electronic device.

18. The remotely operable recording system according to claim 17, wherein said electronic device and said command receiving terminal are located in an integrated unit.

19. The remotely operable recording system according to claim 17, wherein said command receiving terminal is coupled to said electronic device, said coupling being effected by means of a wireless communications link.

20. The remotely operable recording system according to claim 19, wherein said wireless communications link is selected from the group of wireless communications links consisting of: infrared and Bluetooth.

21. The remotely operable recording system according to any one of claims 17 to 20, wherein said electronic device is a recording device.

22. The remotely operable recording system according to claim 21, wherein said recording device is selected from the group of recording devices consisting of: VCR, DVD recorder, hard-disk drives, and flash memory recorders.

23. The remotely operable recording system according to either one of claims 21 and 22, further comprising:
a signal source device providing at least one of an audio and video signal to said recording device.

24. The remotely operable recording system according to any one of claims 17 to 20, wherein said electronic device is a signal source device.

25. The remotely operable recording system according to either one of claims 23 and 24, wherein said signal source device is selected from the group of signal source devices consisting of: a television, a set-top box, a video camera, and a television tuner.

26. The remotely operable recording system according to claim 17, further comprising:
an answering machine providing voicemail facilities.

27. The remotely operable recording system according to claim 26, wherein said voicemail facilities are incorporated within said command receiving terminal.

28. The remotely operable recording system according to claim 17, wherein said received commands are dual tone multi-frequency tones.

29. The remotely operable recording system according to claim 17, wherein said communications network is a telecommunications network, and said command sending terminal is a telephone handset.

30. The remotely operable recording system according to claim 29, wherein said telephone handset is a mobile telephone handset.

31. The remotely operable recording system according to claim 17, further comprising:
a router coupled to said command receiving terminal, said command receiving terminal controlling said electronic device via data transmitted from said command receiving terminal through said router.

32. The remotely operable recording system according to claim 31, wherein said router is coupled to said electronic device using a wireless communications link.

33. The remotely operable recording system according to claim 32 wherein said wireless communications link is selected from the group of wireless communications links consisting of: infrared and Bluetooth.

34. The remotely operable recording system according to claim 17, wherein said electronic device sends information to said command receiving terminal.

35. A remotely operable system, comprising:
a command sending terminal adaptable for coupling to a communications network;
an electronic device operable using wirelessly transmitted commands; and
a command receiving terminal including:
a network interface for coupling to said communications network;
a control interface for coupling to said electronic device;
a memory for storing a set of one or more control commands recognised by said electronic device; and
a processor coupled to the network interface, the control interface, and the memory;
wherein said processor translates at least one operating command received from said command sending terminal via said network interface to at least one of said control commands, said command receiving terminal transmitting said translated control commands via said control interface to control said electronic device.

36. The remotely operable system according to claim 35, wherein said command receiving terminal includes an answering machine.

37. The remotely operable system according to claim 35, wherein said command sending terminal is a mobile telephone handset.

38. The remotely operable system according to claim 35, wherein said command sending terminal is a computing device connected to a communications network.

39. The remotely operable system according to claim 35 wherein said command sending terminal is a personal digital assistant (PDA) connected to a communications network.

40. The remotely operable recording system according to claim 35, wherein said command sending terminal is a touch tone telephone handset.

41. The remotely operable system according to claim 35, wherein said operating commands include commands compatible with a G-code system.

42. The remotely operable system according to claim 35, wherein said operating commands are dual tone multi-frequency commands.

43. The remotely operable system according to any one of claims 35 to 42, wherein said electronic device is a recording device.

44. The remotely operable system according to claim 43, wherein said recording device is selected from the group of recording devices consisting of: VCR, DVD recorder, hard-disk drives, and flash memory recorders.

45. The remotely operable system according to either one of claims 43 and 44, further comprising:
a signal source device providing at least one of an audio and video signal to said recording device.

46. The remotely operable system according to any one of claims 35 to 42, wherein said electronic device is a signal source device.

47. The remotely operable system according to either one of claims 45 and 46, wherein said signal source device is selected from the group of signal source devices consisting of: a television, a set-top box, a video camera, and a television tuner.
